(19) United States
(12) Patent Application Publication
(10) Pub. No.: US 2011/0106599 A1
(43) Pub. Date: May 5, 2011

(54) Providing Digital Coupons for Third Party Network Sites

(76) Inventors: Monica Theresa McCann, Seattle, WA (US); William W. Allocca, Bellevue, WA (US); Brandon R. I. Chang, Seattle, WA (US); Henry Robert Nickerson, Seattle, WA (US); Mark S. Gulbrandsen, Seattle, WA (US); Douglas J. Herrington, Seattle, WA (US); Dilip S. Kumar, Seattle, WA (US); James J. Shimada, Seattle, WA (US); Paul D. DeMarco, Seattle, WA (US)

(21) Appl. No.: 12/608,688

(22) Filed: Oct. 29, 2009

(51) Int. Cl. G06Q 30/00; G06Q 10/00; G06F 3/048

(52) U.S. Cl. 705/14.13; 705/14.23; 705/14.26; 715/760

(57) ABSTRACT

Various embodiments, including systems and methods, are described for providing digital coupons to third party network sites. In one representative embodiment, a computing device is provided, where a plurality of digital coupons are maintained in a memory associated with the computing device. Each digital coupon is directed to the purchase of at least one item through an electronic commerce system. A coupon service is implemented in the computing device that is configured to identify at least one of the digital coupons to present on a third party network site in response to a request for at least one of the digital coupons received from the third party network site based at least in part upon information contained in the request. The identified digital coupons are then sent to the third party network site.

### BACKGROUND

Merchants who sell products over the Internet may wish to offer coupons to consumers in association with the online sale of goods. A problem exists in that many individuals who browse content from various network sites on the Internet may view certain network sites based on their interests. From time to time, the merchant may provide special offers for the purchase of items that are relevant to the interests of such individuals, but such individuals are unaware of such purchase opportunities as they may not frequent the network site of the merchant.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment including various computing devices according to an embodiment of the present disclosure.

FIG. 2 is a drawing of one example of a network page rendered on a display device of a computing device such as a client in the networked environment of FIG. 1 according to an embodiment of the present disclosure.

FIG. 3 is a flowchart that illustrates an example of functionality implemented in a computing device such as a server in the networked environment of FIG. 1 according to an embodiment of the present disclosure.

FIG. 4 is a schematic block diagram that illustrates one embodiment of a computing device such as a server in the networked environment of FIG. 1 according to an embodiment of the present disclosure.

### DETAILED DESCRIPTION

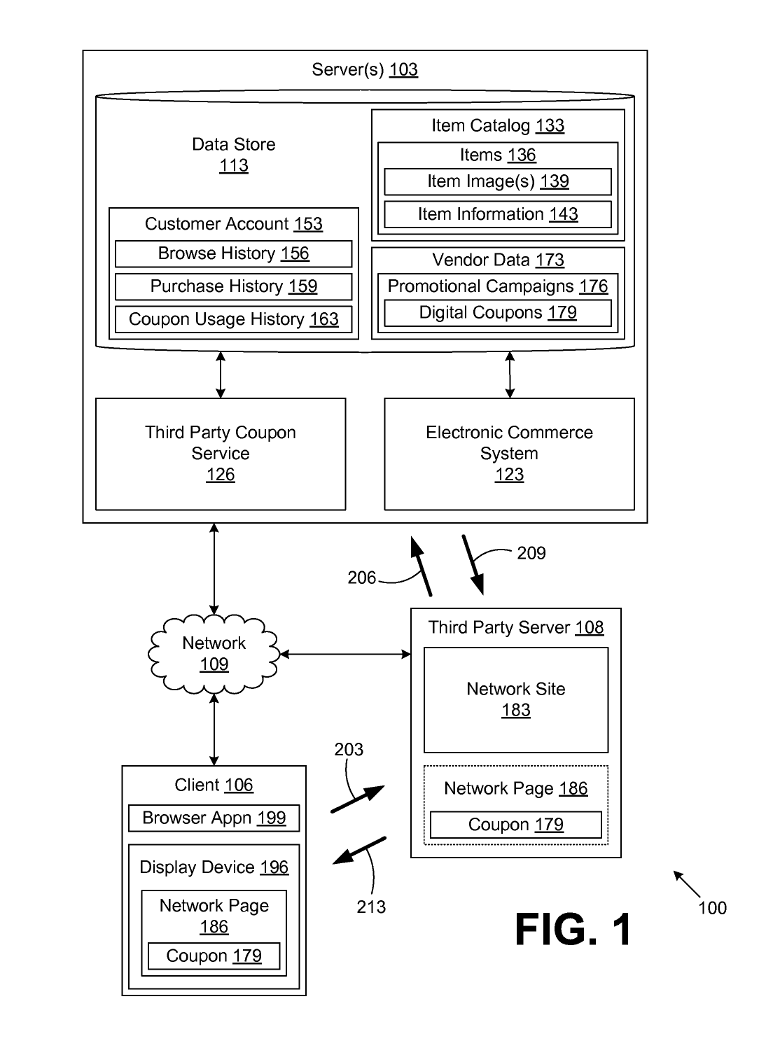

With reference to FIG. 1, the following relates to the implementation of coupons in a networked environment 100 in association with the activities of a merchant that sells goods and/or services online over a network such as the Internet. In the following discussion, first a description of the physical nature of the networked environment 100 is provided followed by a description of the operation of the same. More detailed discussion of various aspects is provided with respect to later figures.

The networked environment 100 depicted in FIG. 1 includes various computing devices such as, for example, a server 103, a client 106, a third party server 108, and/or other computing devices that are coupled to a network 109. The network 109 may comprise, for example, the Internet, intranets, extranets, wide area networks (WANs), local area networks (LANs), wired networks, wireless networks, or other suitable networks, etc., or any combination of two or more such networks. For purposes of convenience, the servers 103 and 108, and the client 106 are each referred to herein in the singular. However, it is understood that in one embodiment, the servers 103 and 108 may represent a plurality of servers, and the client 106 may represent a plurality of clients.

Each of the servers 103 and 108 comprises one example of a computing device that may be employed to execute various components as described herein. Each server 103 or 108 may comprise, for example, a server computer or like system, and may represent multiple servers arranged, for example, in one or more server banks or other arrangements. Such servers may be located in a single installation or may be dispersed among many different geographical locations. To this end, each server 103 or 108 may be viewed as a server “cloud” that represents the computing capacity of multiple servers, etc.

Various applications and/or engines are executed in the server 103 according to various embodiments. Also, various data may be stored in a data store 113 that is accessible to the server 103. The data stored in the data store 113, for example, may be associated with the operation of the various applications and/or engines described below. The applications executed in the server 103 may include, for example, an electronic commerce system 123, a third party coupon service 126, and other applications not discussed in detail herein.

The electronic commerce system 123 is configured to conduct electronic commerce to facilitate the network presence of one or more online merchants. The electronic commerce system 123 may comprise may different applications, components, and/or systems implemented on a plurality of computing devices such as the server 103 that are located at one site, or are distributed among geographically diverse sites as can be appreciated. The third party coupon service 126 is configured to provide content to the third party server 108 as will be described.

The applications, components, and/or systems included in the electronic commerce system 123 provide for various functions such as maintaining and accessing an item catalog 133 in which is stored data describing a plurality of items 136 sold to customers by an online merchant. The data describing each of the items 136 may include item images 139 and item information 143. The items 136 sold through the electronic commerce system 123 may comprise, for example, goods and/or services.

The electronic commerce system 123 may also provide for various functions such as, for example, searching for items 136, generating network pages with search results or for other purposes, implementing the purchase of items 136, effecting payment for items 136 purchased, and other functions. In providing for the purchase of items 136, the electronic commerce system 123 may generate a plurality of different network pages such as web pages or other network content that is served up to various clients 106 controlled by customers. Such network pages may be static or created dynamically.

In addition, various customer accounts 153 may be maintained in the data store 113. Each customer account 153 may include customer data that describes the customer including payment addresses, delivery addresses, payment instruments, and other data used to consummate various commercial transactions. Also associated with each of the customer accounts 153 are a browse history 156, purchase history 159, coupon usage history 163, and potentially other data. In one embodiment, the coupon usage history 163 may actually be included as part of the purchase history 159 as can be appreciated.

In addition, vendor data 173 is stored in the data store 113 that describes information about various vendors such as manufacturers and other types of vendors that produce or otherwise provide items 136 that are sold through the electronic commerce system 123. The vendor data 173 may include information about respective vendors including address and contact information, banking information, supply contract information, and other information not important for the purposes of this discussion that is needed to transact business with such vendors as can be appreciated. The vendor data 173 specifically includes data that describes various promotional campaigns 176 that are launched by vendors to provide greater incentives to their customers to purchase the items 136 they offer. According to one embodiment, one or more digital coupons 179 are associated with each of the promotional campaigns 176 as will be described. As contemplated herein, a digital coupon 179 comprises a digital instrument that may be selected by a user that entitles the user to redeem a benefit in association with a purchase of one or more items 136. Such a benefit may comprise, for example, a discount off of a purchase price for one or more items 136, whether the discount is a fixed dollar amount or a percentage of the purchase price. The benefit may also comprise, for example, giveaways of additional items 136, free shipping for items 136, discounts (fixed or percent reduction) for items 136 related to items 136 purchased, or other benefits.

In addition, associated with one or more of the digital coupons 179 is data that indicates a degree to which a preference is to be applied to the digital coupons 179 based on payment by vendors for greater exposure for such digital coupons 179 as will be described.

The third party server 108 is employed to implement a network site 183. The network site 183 is configured to encode various network pages 186 for display on various clients 106. The network pages 186 include content or subject matter presented by the network site 183 in accordance with the purpose of the network site 183. In one embodiment, the network pages 186 comprise web pages or other types of content as can be appreciated. The network site 183 may be referenced on the network 109 with an appropriate network address such as a web address, etc. To cite a specific example, the network site 183 may comprise a blog, a special interest site, a merchant site, or any other type of network site 183.

When encoding network pages 186, the network site 183 is configured to include one or more digital coupons 179 along with the content of such network pages 186. To this end, the network site 183 obtains digital coupons 179 from the third party coupon service 126 as will be described.

The client 106 is representative of a plurality of client devices that may be coupled to the network 109. For example, the client 106 may comprise one of millions of clients 106 coupled to the Internet. The client 106 may comprise, for example, a processor-based system such as a computer system. Such a computer system may be embodied in the form of a desktop computer, a laptop computer, a personal digital assistant, a cellular telephone, set-top box, music players, web pads, tablet computer systems, or other devices with like capability.

The client 106 may include, for example various peripheral devices. In particular, the peripheral devices may include input devices such as, for example, a keyboard, keypad, touch pad, touch screen, microphone, scanner, mouse, joystick, or one or more push buttons, etc. The peripheral devices may also include a display device 196, indicator lights, speakers, etc. The display device 196 may comprise, for example, cathode ray tubes (CRTs), liquid crystal display (LCD) screens, gas plasma-based flat panel displays, LCD projectors, or other types of display devices, etc.

Executed within the client 106 are various applications including a browser application 199. The client browser application 199 is configured to interact with the electronic commerce system 123 and potentially other applications on the servers 103 or 108 according to an appropriate protocol such as the Internet Protocol Suite comprising Transmission Control Protocol/Internet Protocol (TCP/IP) or other protocols. To this end, the browser application 199 may comprise, for example, a commercially available browser such as INTERNET EXPLORER™ sold by Microsoft Corporation of Redmond, Wash., or MOZILLA FIREFOX™ which is promulgated by Mozilla Corporation of Mountain View, Calif., or other type of browser. Alternatively, the browser application 199 may comprise some other application with like capability. When executed in the client 106, a user may employ the browser application 199 to access the network pages 186 served up by the network site 183. The browser application 199 is configured to render the network pages 186 including the digital coupons 179 on the display device 196 and to perform other functions. Also, the browser application 199 may implement the execution of active portions of a network page 186 as can be appreciated.

Next, a general description of the various components of the networked environment 100 is provided. To begin, it is assumed that a user of the client 106 wishes to access the network site 183 served up by the third party server 108. Specifically, it is assumed that the user wishes to view various network pages 186 encoded by the network site 183 for rendering on the client 106. To do so, the user manipulates the browser application 199 by inputting a network address associated with the network site 183. Ultimately, a request 203 is sent from the client 106 to the third party server 108 for a network page 186 that is responsive to the address entered into the browser application 199.

The network site 183 is configured to present various subject matter or content that is ultimately accessible, for example, to some or all of the clients 106 on the network 109. A portion of the network pages 186 generated by the network site 183 is used to include digital coupons 179 that are applicable for the purchase of items 136 through the electronic commerce system 123. Upon receiving the request 203 from the client 106, the network site 183 proceeds to encode the network page 186 responsive 203 to the request for rendering on the client 106. In the process of encoding the network page 186, the network site 183 sends a request 206 through the network 109 to the third party coupon service 126 on the server 103 for one or more digital coupons 179 to be included in a respective portion of the network page 186 to be rendered on the client 106 along with the network page 186. The request 206 may indicate, for example, the number of digital coupons 179 desired.

In response to the request 206, the third party coupon service 126 obtains one or more digital coupons 179 from the data store 113 that are currently active for use in association with the operation of the electronic commerce system 123 in selling various items 136. In determining the one or more digital coupons 179 to provide back to the network site 183 in response to the request 206, the third party coupon service 126 may take into account various information provided to it by the network site 183.

For example, the network site 183 may have knowledge of the identity of the user of a client 106. This may be obtained from cookies stored in association with the browser application 199 in the client 106, or from a login performed by the user when initially accessing the network site 183. The identity of the user of the client 106 may be provided to the third party coupon service 126 that may look up an appropriate customer account 153 associated with such a user. This makes the browse history 156, purchase history 159, coupon usage history 163, and other information associated with the customer account 153 available to identify appropriate digital coupons 179 most relevant to the individual. Further, other factors may be examined in determining which digital coupons 179 to provide to the network site 183 to be presented to the specific user.

Alternatively, in some cases the identity of the user of the client 106 may be unknown to the electronic commerce system 123. In such cases, the electronic commerce system 123 may try to determine any information about the unknown customer to the degree possible. In one embodiment, the electronic commerce system 123 may attempt to determine a geographical location of the customer based on the Internet Protocol (IP) address associated with the client 106. To this end, the electronic commerce system 123 may examine the progression of network pages 186 viewed by the customer to obtain their IP address and other information. Various techniques may be employed to determine a geographical location of the user based on their IP address and other information as described in U.S. patent application entitled “Mapping Attributes to Network Addresses” filed on Jun. 29, 2007 and assigned application Ser. No. 11/771,679, which is incorporated herein by reference in its entirety. The geographical location information known about the customer may be employed as a factor to determine which digital coupons 179 are relevant to be considered for inclusion in a given network page 186. For example, some items 136 may be regional in nature.

In addition, the network site 183 may include in the request 206 information about the content of the network page 186 to be served up to the client 106. For example, such information may include a description of a product such as an item 136 or other information to which it is requested that a digital coupon 179 be directed. The information may include descriptive information where the purpose of the network site 183 is to describe or memorialize information about one or more topics. Such information may comprise key words, metadata, or other description information. The third party coupon service 126 may identify respective digital coupons 179 that are relevant to the information provided to send back to the network site 183 to include in the network page 186. In addition, other factors and considerations may be taken into account when determining which digital coupons 179 to send to the network site 183 in response to the request 206.

After the third party coupon service 126 identifies one or more digital coupons 179 that are to be sent to the network site 183, the third party coupon service 126 sends a reply 209 that includes such digital coupons 179 to the network site 183. In one embodiment, the reply 209 may includes links or references to respective digital coupons 179 on the network 109 that can be incorporated in the network page 186 rather than sending the digital coupons 179 themselves. Ultimately, when the network page 186 is served up to the browser application 199 in the client 106, the browser application 199 will act upon such links or references to download respective digital coupons 179 from the server 103 as can be appreciated.

Upon receiving the reply 209, the network site 183 proceeds to finish encoding the network page 186 including the one or more digital coupons 179 as mentioned above. To this end, the network site 183 may include the actual content of the digital coupons 179 in the network page 186, or may include a reference or link to such content to be downloaded by the browser application 199 as described above. Thereafter, a reply 213 is sent in response to the request 203 from the client 106 that includes the network page 186. Upon receiving the network page 186, the browser application 199 renders the same on the display device 196.

In addition, the third party coupon service 126 may be configured to track the number of impressions that have occurred for each digital coupon 179 sent to the network site 183 and included in a respective network page 186 sent to a client 106. In addition, the network site 183 may also track the same information. Also, the electronic commerce system 123 or the third party coupon service 126 may be configured to track the number of times a user is referred to the electronic commerce system 123 through the at least one of the digital coupons 179.

Once a digital coupon 179 is presented to a customer in a network page 186, then customers may click on or otherwise select the digital coupons 179 in association with items 136 they wish to purchase. According to one embodiment, the electronic commerce system 123 tracks those digital coupons 179 clicked on or otherwise selected by customers and automatically applies the respective benefits offered by those digital coupons 179 at checkout when such items 136 are purchased. Stated another way, once a user has clicked on or otherwise selects a digital coupon 179 presented, they are directed to the network site of the electronic commerce system 123 and are automatically eligible to receive the benefit associated with the digital coupon 179 when they proceed to checkout. This provides an advantage in that the user need not perform further actions to redeem the digital coupon 179 other than to specify the items 136 they wish to purchase. Alternatively, the redemption of digital coupons 179 may be implemented in some other manner.

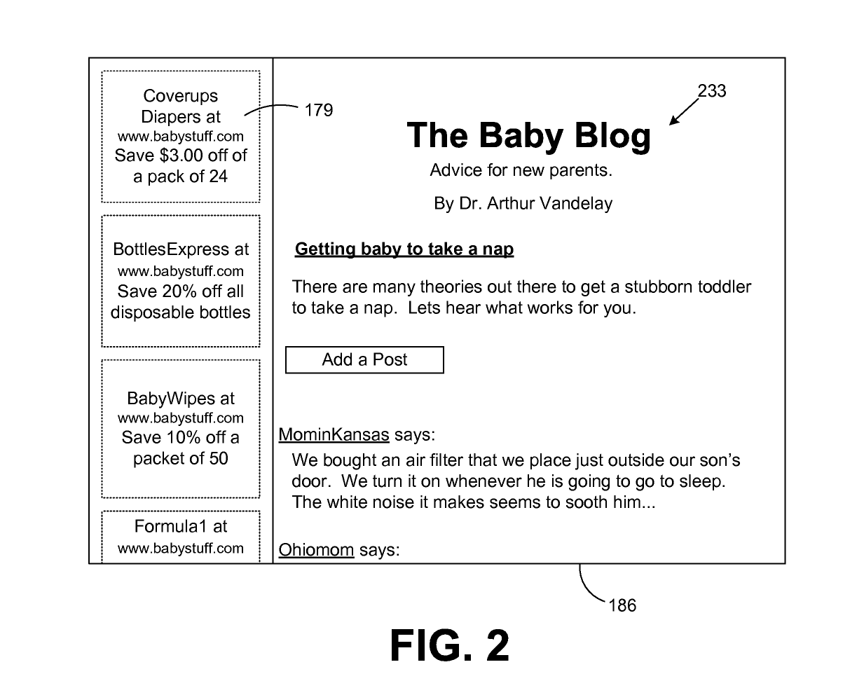

With reference to FIG. 2, shown is one example of a network page 186 that may be served up by a network site 183 (FIG. 1) according to various embodiments of the present disclosure. As shown, the network page 186 comprises a blog for new parents entitled “The Baby Blog.” The blog comprises subject matter 233 of the network page 186. In one embodiment, a user may be required to log onto the network site 183 (FIG. 1) using an appropriate username and password or other authentication information as can be appreciated. Thus, in generating the network page 186 to send to the client 106 (FIG. 1), the network site 183 may have knowledge of the identity of the user.

Alternatively, various components such as cookies may be stored in the client 106 in association with the browser application 199 (FIG. 1) that informs the network site 183 of the identity of the user. Such cookies or other components may be included in the client 106 due to the access by a user of the client 106 of the operations of the electronic commerce system 123 (FIG. 1), where the electronic commerce system 123 may serve up various network pages in association with the conduct of electronic commerce as described above. Where the network site 183 may obtain the identity of a user of the client 106 based on cookies or other components associated with the browser application 199, the network site 183 may send this information to the third party coupon service 126 (FIG. 1) along with a request 206 (FIG. 1) for one or more digital coupons 179 as described above.

In addition to the subject matter 233, the network page 186 also includes several digital coupons 179. According to one embodiment, each of the digital coupons 179 may comprise a link to a network page generated by the electronic commerce system 123 to present one or more items 136 (FIG. 1) that are the subject of the digital coupons 179 themselves. Thus, in generating a network page 186, the network site 183 may act as a broker to direct users of the client 106 to a landing page generated by the electronic commerce system 123 operated by a given merchant to facilitate the purchase of items 136.

An arrangement may be made between the operator of the network site 183 and the merchant that operates the electronic commerce system 123 to pay a commission for all sales based on referrals from digital coupons 179 displayed on network pages 186 generated by the network site 183. Alternatively, the operator of the network site 183 may be paid an amount for each impression of each digital coupon 179 in a given network page 186 delivered to the client 106. This provides incentive for the operator of a network site 183 to include digital coupons 179 for items 136 in the network pages 186 generated by the network site 183. Such an arrangement serves to drive customers to the electronic commerce system 123 and increase sales.

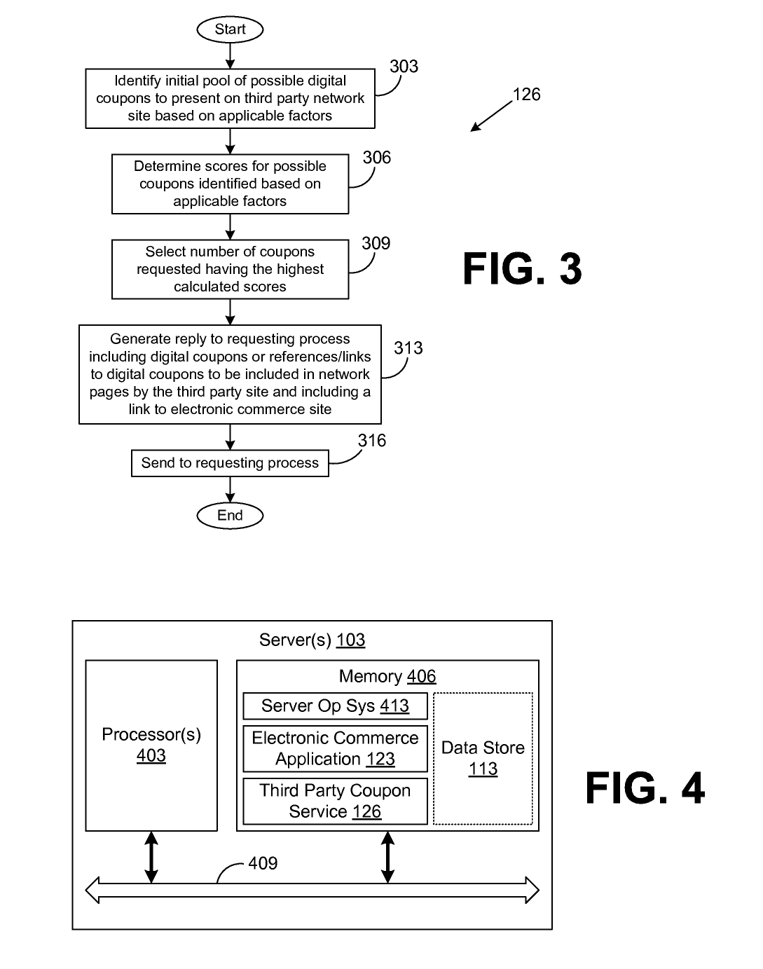

With reference next to FIG. 3, shown is a flowchart that provides one example of functionality of the third party coupon service 126 in identifying digital coupons 179 (FIG. 1) to be encoded within network pages 186 (FIG. 1) by a network site 183 (FIG. 1) as described above. Alternatively, the flowchart of FIG. 3 may be viewed as depicting steps of a method implemented in the server 103 (FIG. 1) as can be appreciated.

To begin, in box 303, the third party coupon service 126 identifies an initial pool of relevant digital coupons 179 to present to a customer. There may be several factors that are taken into account to determine whether a given digital coupon 179 is relevant for purposes of consideration as to whether such digital coupon 179 should be included in a network page 186. Factors requiring knowledge of the identity of the customer are generally considered when the identity of the customer is known as can be appreciated.

Among the various factors that may be considered are whether an affinity exists between or among two or more digital coupons 179, where the respective user has previously selected or redeemed one of the digital coupons 179 in the pair or group. For example, the affinity between digital coupons 179 may be identified by identifying among several customer accounts 153 (FIG. 1) that a threshold number of customers who redeem a first digital coupon 179 also tend to redeem a given second digital coupon 179. An affinity may be recognized when the number of customers who exhibit such behavior has reached a threshold number of users or when some other standard may be applied. Thus, any digital coupons 179 that have an affinity with other digital coupons 179 redeemed on a prior occasion by the customer as determined by the coupon usage history 163 (FIG. 1) associated with the customer may be deemed relevant for purposes of presentation to the customer.

Another factor involves whether increased exposure is to be given for digital coupons 179 for respective vendors who pay a fee for such treatment. Such vendors may pay a fee to increase the probability that one or more digital coupons 179 will be selected for inclusion in a given network page 186 generated by the electronic commerce system 123 (FIG. 1). Thus, for example, where other factors may not indicate a strong relationship or relevance to the generation of the current network page 186, it may be that enhanced exposure paid for by a respective vendor may cause such digital coupon 179 to be selected for inclusion in the network page 186 currently under construction.

Still other factors that may be considered in selecting digital coupons 179 for inclusion in a network page 186 currently under construction may include the conversion rates and/or impression rates associated with such digital coupons 179. For example, a digital coupon 179 that has an unusually high conversion rate indicates the popularity of such a digital coupon 179 relative to other digital coupons 179, thereby increasing the desirability of such digital coupon 179 for selection to include in the network page 186 under construction. As contemplated herein, the concept of “conversion” involves the user clicking on a given digital coupon 179 or otherwise taking such actions so as to redeem the digital coupon 179. Alternatively, the concept of conversion may include clicking on or otherwise manipulating a digital coupon 179 in order to learn more about it, etc. As such, conversion may include any action taken with respect to a given digital coupon 179 by a customer.

The impression rate of a given digital coupon 179 involves the number of times that the digital coupon 179 is used in the creation of network pages 186. A higher impression rate potentially indicates a greater relevance to the creation of various network pages 186. Alternatively, a higher impression rate may indicate the overuse of a given digital coupon 179, thereby indicating that it is less desirable to include in a given network page 186.

In addition, the third party coupon service 126 may examine the past browse history 156 (FIG. 1) and past purchase history 159 (FIG. 1) associated with a respective customer to identify past items 136 (FIG. 1) viewed or purchased. Such items 136 may indicate the interests in the customer in making purchases. Accordingly, a digital coupon 179 may be deemed of greater interest for inclusion in a given network page 186 if it involves subject matter similar to the subject matter viewed or searched in the browse history 156 associated with a given user. Also, a given digital coupon 179 may be deemed more desirable to include in a network page 186 under construction provided that the subject matter of the digital coupon 179 is similar to the subject matter of products purchased in the past.

To this end, if the browse history 156 and/or the purchase history 159 indicate a hobby of a user, then digital coupons 179 related to such hobby would be relevant to the network page 186 under construction. For example, if a customer views and purchases tents and camping equipment, such a customer may be an outdoor enthusiast. Consequently, this indicates that digital coupons 179 relating to outdoors equipment and the like may be more desirable for inclusion in a given network page 186 to be rendered for such a customer.

Another factor involves the subject matter of the network page 186 under construction. Specifically, digital coupons 179 identified as related to the subject matter of the network page 186 may be deemed important to include in the network page 186. This is especially the case if the network site 183 is directed to specific subjects such as gardening sites, historical sites, and other network sites 183.

In addition, the coupon usage history 163 may be examined to identify digital coupons 179 that the customer had previously redeemed that may be similar in subject matter to the digital coupons 179 under consideration. Those digital coupons 179 that may be deemed relevant to past redeemed digital coupons 179 may be included in the initial pool of relevant digital coupons 179.

Yet another factor to consider is the geographical location of the customer in situations where the customer is unknown and address information in a respective one of the customer accounts 153 is not available. In such case, the various approaches may be consulted as described in U.S. patent application entitled “Mapping Attributes to Network Addresses” filed on Jun. 29, 2007 and assigned application Ser. No. 11/771,679, which is incorporated herein by reference in its entirety. Such approaches may provide a general geographical location or other information about a customer. Various digital coupons 179 may be relevant to the geographical location of the customer.

In addition, there may be many other factors to consider in determining whether a given digital coupon 179 is relevant to the network page 186 under construction to the extent that it should be included in the initial pool of digital coupons 179 to be considered for presentation to the user in box 303.

Assuming that the initial pool of digital coupons 179 is identified in box 303 as mentioned above, then the third party coupon service 126 proceeds to box 306 in order to calculate a score for each of the digital coupons 179 included in the initial pool for purposes of determining a priority of such digital coupons 179 for presentation to the customer in the current network page 186 to be sent to the client 106. In order to calculate the score for each of the digital coupons 179, various approaches may be employed. In one example, an equation may be used that comprises a weighted summation of values, where each of the values is derived from any one of a number of factors as described above. For example, such a formula may be stated as follows:

Score=C₁f₁+C₂f₂+C₃f₃+ . . . +C_{N}f_{N}.

As set forth above, each factor f is weighted by a constant C that may be assigned based on experience to indicate the relative importance of each factor f in considering the score for a given digital coupon 179. Each of the factors f may comprise, for example, the affinity between respective digital coupons 179 as mentioned above. Specifically, such an affinity may comprise situations where it is determined that customers who redeem or otherwise show interest in a first digital coupon 179 also redeem or show interest in a second digital coupon 179 as described above. Another factor f may provide for a degree of increased exposure due to payment received from a vendor. In addition, other factors f may involve conversion rates and/or impression rates as described above.

Further, other factors f to consider include the relevance of a digital coupon 179 to the subject matter of the browse history 156 of the customer, the subject matter of the purchase history 159 of the customer, or the subject matter of the coupon usage history 163 is described above. In addition, there may be other factors not described herein that may be considered in calculating a score for a respective digital coupon 179.

In order to quantify a value for each of the respective factors, one may examine the factor f relevant to other instances of a same factor for other subject matter, etc. For example, the determination may be made as to the strength of a given affinity between two digital coupons 179 based upon the number of different customers that have redeemed both digital coupons 179 relative to other such affinities identified. The greater the number of customers who have shown such an affinity relative to the average affinity experienced with other pairs of digital coupons 179, the greater the value assigned. Also, a value may be assigned with respect to the payment for increased exposure by a given vendor. Similarly, values may be assigned to respective conversion rates and impression rates relative to the average conversion rates and impression rates associated with other digital coupons 179. In addition, various algorithms may be employed to determine the relevance of a given digital coupon 179 to the subject matter of a browse history 156, purchase history 159, and/or coupon usage history 163, etc.

In addition, another factor may comprise a geographical location of a customer as determined from an IP address as described in U.S. patent application entitled “Mapping Attributes to Network Addresses” filed on Jun. 29, 2007 and assigned application Ser. No. 11/771,679, which is incorporated herein by reference in its entirety. A value may be obtained indicating the degree to which a given digital coupon 179 is relevant to a geographical location or other factor identified as described in the above-referenced patent application. Thus, in box 306, a score is calculated for each of the digital coupons 179 identified in the initial pool of digital coupons 179 in box 303 above.

Next, in box 309, one or more of the digital coupons 179 having the highest calculated scores are selected to send to the network site 183. Such digital coupons 179 having the highest scores calculated are selected to be sent to the network site 183 as they are deemed to have the highest probability of being redeemed by individuals who access the network site 183, or have been deemed important to send to the network site 183 for other reasons.

Thereafter, in box 313, the third party coupon service 126 encodes the digital coupons 179 for inclusion in a given network page 186 by the network site 183. Such digital coupons 179 would be included in the reply 209 (FIG. 1) sent to the third party server 108 (FIG. 1). Alternatively, rather than including the actual digital coupons 179, the third party coupon service 126 may provide references or links to such digital coupons 179 in the data store 113 (FIG. 1) to the network site 183 to include in the network page 186, where the browser application 199 (FIG. 1) accesses such digital coupons 179 by using the references or links included in the network page 186.

In addition, the reply 209 may include a link or reference to the electronic commerce system 123 on the network 109 (FIG. 1) that is associated with the respective digital coupons 179 to direct a user of the client 106 to the electronic commerce system 123 in the event that they click on or otherwise manipulate the respective digital coupons 179 displayed on the display device 196 (FIG. 1) as described above. Thereafter, in box 316, the third party coupon service 126 sends the reply 209 including the digital coupons 179 or references/links thereto to the network site 183. Thereafter, the function of the third party coupon service 126 ends as shown.

Referring next to FIG. 4, shown is a schematic block diagram of one example of a server 103 according to an embodiment of the present disclosure. The server 103 includes at least one processor circuit, for example, having a processor 403 and a memory 406, both of which are coupled to a local interface 409. To this end, the server 103 may comprise, for example, a server computer system or like device as described above. The local interface 409 may comprise, for example, a data bus with an accompanying address/control bus or other bus structure as can be appreciated.

Stored in the memory 406 are both executable applications and/or systems executed by the processor 403 and data. In particular, stored in the memory 406 and executable by the processor 403 are a server operating system 413, the electronic commerce system 123, the third party coupon service 126, and potentially other applications and/or systems, etc. Also, stored in the memory 406 is the data store 113 in which are stored the various data items described above so as to be accessible to the processor 403. It is understood that other data may be stored in the memory 406 and accessed by the processors 403 beyond the data described above.

A number of software components are stored in the memory 406 and are executable or executed by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 403 may represent multiple processors and the memory 406 may represent multiple memories that operate in parallel. In such a case, the local interface 409 may be an appropriate network that facilitates communication between any two of the multiple processors, between any processor and any one of the memories, or between any two of the memories etc. The local interface 409 may comprise additional systems designed to coordinate this communication, including, for example, performing load balancing. The processor 403 may be of electrical or of some other available construction.

The various applications or other components described above may be implemented using any one or more of a number of programming languages such as, for example, C, C++, C#, Visual Basic, VBScript, Java, JavaScript, Perl, Ruby, Python, Flash, or other programming languages.

Although the various applications and other components such as the electronic commerce system 123 and/or the third party coupon service 126 described above may be embodied in software or code executed by general purpose hardware, as an alternative each may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of the various applications and/or other components such as the third party coupon service 126 as described above. If embodied in software, each of the various blocks described may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the various applications, systems, and/or other components described herein such as the electronic commerce system 123 and/or the third party coupon service 126 comprise software or code, each can be embodied in any computer-readable medium for use by or in connection with an instruction execution system such as, for example, a processor in a computer system or other system. In this sense, the applications or engines may comprise, for example, statements including instructions and declarations that can be fetched from the computer-readable medium and executed by the instruction execution system. In the context of the present disclosure, a “computer-readable medium” can be any medium that can contain, store, or maintain logic or code for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a computing device;
a plurality of digital coupons maintained in a memory associated with the computing device, each digital coupon being directed to the purchase of at least one item through an electronic commerce system; and
a coupon service implemented in the computing device, the coupon service being configured to:
identify at least one of the digital coupons to present on a third party network site in response to a request for at least one of the digital coupons received from the third party network site based at least in part upon information contained in the request, wherein the information comprises an identity of a user, and a description of a subject matter of the third party network site, wherein the at least one of the digital coupons is identified based at least in part upon information about the user stored in association with an operation of the electronic commerce system, and the description of the subject matter of the third party network site;
associate a link to the electronic commerce system with the at least one of the digital coupons; and
send the at least one of the digital coupons to the third party network site.

2. The system of claim 1, wherein the coupon service is further configured to:
identify information about an item identified in the request; and
identify the at least one of the digital coupons directed to the item.

3. The system of claim 1, wherein the coupon service is further configured to identify a plurality of the digital coupons in response the request.

4. A method, comprising the steps of:
maintaining a network site in a computing device, the network site presenting a subject matter accessible to a plurality of clients;
providing a portion of a network page associated with the network site for presentation of a digital coupon applicable for a purchase of an item through an electronic commerce system;
encoding the network page for rendering on one of the clients in the computing device; and
requesting, in the computing device, the digital coupon from a third party network site for inclusion in the portion of the network page encoded for rendering on the one of the clients.

5. The method of claim 4, further comprising the steps of:
including the digital coupon received from the third party network site in the portion of the network page; and
sending the network page to the one of the clients.

6. The method of claim 5, wherein the digital coupon further comprises a link to the third party network site.

7. The method of claim 4, further comprising the steps of:
authenticating a user of one of the clients; and
providing an identification of the user to the third party network site with the request for the digital coupon.

8. The method of claim 4, further comprising the step of including information describing the subject matter of the network site with the request for the digital coupon.

9. The method of claim 4, further comprising the step of including information describing a product to which the digital coupon is to be directed along with the request for the digital coupon.

10. The method of claim 4, further comprising the step of obtaining an identity of a user of the one of the clients from a cookie stored in the client.

11. The method of claim 4, further comprising the step of tracking a number of impressions for the digital coupon as a portion of the network page.

12. The method of claim 11, wherein a fee is paid to an operator of the network site for each of the impressions.

13. A system, comprising:
a computing device;
a plurality of digital coupons maintained in a memory associated with the computing device, each digital coupon facilitating a redemption of a benefit in association with a purchase of at least one item through an electronic commerce system; and
a coupon service implemented in the computing device, the coupon service being configured to:
identify at least one of the digital coupons to present on a third party network site in response to a request for at least one of the digital coupons received from the third party network site based at least in part upon information contained in the request; and
send the at least one of the digital coupons to the third party network site.

14. The system of claim 13, wherein the coupon service is further configured to:
determine an identity of a user from the request; and
identify the at least one of the digital coupons based at least upon information about the user stored in association with an operation of the electronic commerce system.

15. The system of claim 13, wherein the coupon service is further configured to track a number of impressions of each of the digital coupons on the third party network site.

16. The system of claim 13, wherein the electronic commerce system is configured to track a number of times a user is referred to the electronic commerce system through the at least one of the digital coupons.

17. The system of claim 13, wherein the coupon service is further configured to associate a link to the electronic commerce system with the at least one of the digital coupons.

18. The system of claim 17, wherein the electronic commerce system automatically applies the digital coupon to the purchase of the item.

19. The system of claim 13, wherein the coupon service is further configured to:
identify information about a subject matter of the third party network site from the request; and
identify the at least one of the digital coupons based at least upon information about the subject matter of the third party network site.

20. The system of claim 13, wherein the coupon service is further configured to:
identify information about an item identified in the request; and
identify the at least one of the digital coupons directed to the item.

21. The system of claim 13, wherein the coupon service is further configured to identify a plurality of the digital coupons in response the request.

22. The system of claim 13, wherein the coupon service is further configured to:
identify information about a subject matter of the third party network site from the request; and
identify the at least one of the digital coupons based at least in part upon a preference given to the digital coupons.
